(19) United States
(12) Patent Application Publication
(10) Pub. No.: US 2016/0085331 A1
(43) Pub. Date: Mar. 24, 2016

(54) Method and Apparatus for Physical Activity Tracking

(71) Applicant: Omron Healthcare, Inc., Lake Forest, IL (US)

(72) Inventors: Nobuo Kubo, Buffalo Grove, IL (US); Rodney Hal Monson, Waukegan, IL (US); Garrett Lee Winther, Chicago, IL (US); Ross Lockwood, Chicago, IL (US); Travis Schultz Lee, Chicago, IL (US); Shu Kuen Chang, Evanston, IL (US); Florian Maximilian Friedrich Gerlach, Trofaiach (AT)

(21) Appl. No.: 14/857,424

(22) Filed: Sep. 17, 2015

Related U.S. Application Data
(60) Provisional application No. 62/052,198, filed on Sep. 18, 2014.

(51) Int. Cl. G06F 3/041; G06F 1/16; G06F 3/01

(52) U.S. Cl. CPC G06F 3/041; G06F 3/017; G06F 1/163; G06F 2203/04104

(57) ABSTRACT

In one aspect of the teachings herein, a physical activity tracking system includes a wearable electronic device that uses dual touch points for detecting control inputs by a user. Processing within the device complements the dual touch point interface by requiring simultaneous touch detections to register user inputs to the device, and by mapping dual-touch detections of different duration to different control actions. Use of the dual-touch arrangement and the associated processing provides a number of advantages, including intuitive operation and minimization of accidental activations by the user. Other advantages of the touch interface include the ability to seat or mount the device in a variety of carriers, such as bracelets, etc., that complement wearability of the device, while still allowing for convenient charging.

### RELATED APPLICATIONS

This application claims priority under 35 U.S.C. §119(e) from the provisional U.S. application filed on 18 Sep. 2014 and identified by App. No. 62/052,198.

### TECHNICAL FIELD

The present invention relates to tracking physical activity and particularly relates to a tracking device, associated communication devices, and an online server that cooperatively provide a system for tracking physical activity.

### BACKGROUND

A growing interest in adopting and maintaining healthy lifestyles corresponds to the growing “wearables” market and the device and information ecosystems supporting them. “Wearables” here means electronic devices that are designed to be worn, carried or affixed to their users. Some wearables are information-centric, such as seen in the various smart-watch solutions available in the consumer market. Many wearables, however, focus on user fitness and provide a range of fitness-related tracking functions.

Well-known functions include step counting and caloric consumption. As sensor technologies improve, along with improvements in battery technology and low-power circuitry, additional functions are becoming more common. Examples include continuous heart-rate monitoring, GPS tracking, and the like.

However, designing a wearable fitness tracker and developing a corresponding overall physical activity tracking system poses many challenges. Users expect convenience but the concept of convenience becomes complex in the wearables category. Wearables must be small enough to be unobtrusive, but users more broadly seek a satisfying “user experience.”

Providing such experiences requires system designers and manufacturers to balance aesthetics against practicality and durability, all while minding cost limits and underlying performance requirements. It is recognized herein that the form factor of a wearable device must provide intuitive, hassle-free operation for the active user, while simultaneously harmonizing aesthetics, form factor considerations, and the ability to seamlessly integrate the device into an overall physical activity tracking system.

### SUMMARY

In one aspect of the teachings herein, a physical activity tracking system includes a wearable electronic device that uses dual touch points for detecting control inputs by a user. Processing within the device complements the dual touch point interface by requiring simultaneous touch detections to register user inputs to the device, and by mapping dual-touch detections of different duration to different control actions. Use of the dual-touch arrangement and the associated processing provides a number of advantages, including intuitive operation and minimization of accidental activations by the user. Other advantages of the touch interface include the ability to seat or mount the device in a variety of carriers, such as bracelets, etc. Mounting flexibility complements the wearability and usability of the device, while still allowing for convenient charging.

In an example embodiment, a wearable electronic device includes a housing having an exterior surface and electronic circuitry mounted within the housing. The electronic circuitry includes a touch-sensing circuit configured to provide two touch points on the exterior surface of the housing, where the two touch points are physically separated on the exterior surface so as to prevent accidental touch activation of the wearable electronic device by a user. The electronic circuitry further includes a processing circuit operatively associated with the touch-sensing circuit and configured to control one or more functions of the wearable electronic device, responsive to detecting dual-touch events in which the user simultaneously touches both touch points.

In another embodiment, a physical activity tracking system includes a wearable electronic device configured for tracking the physical activity of a user. The wearable electronic device includes a housing having an exterior surface and electronic circuitry mounted within the housing. The electronic circuitry includes a touch-sensing circuit configured to provide two touch points on the exterior surface of the housing, where the two touch points are physically separated on the exterior surface so as to prevent accidental touch activation of the wearable electronic device by the user. Further included are a display positioned beneath a transparent region of the exterior top surface of the housing and configured to display one or more items of information to the user, at least one sensor for sensing physical activity of the user, including at least one of a motion sensor and a barometric pressure sensor, and a processing circuit operatively associated with the touch-sensing circuit, the display and the at least one sensor.

The processing circuit is configured to track the physical activity of the user based on processing sensor output from the at least one sensor. Further, the processing circuit is configured to control operation of the wearable electronic device, including operation of the display, responsive to detecting dual-touch events in which the user simultaneously touches both touch points.

In yet another embodiment, a physical activity tracking system includes a wearable electronic device configured for tracking the physical activity of a user. The wearable electronic device includes a housing having an exterior surface defining an interior space, and a clip assembly that includes an external clip comprising an elongate member extending along an exterior bottom surface of the housing and having first and second ends, an internal spring comprising an elongate member having first and second ends extending within the interior space of the housing roughly parallel to the external clip when the external clip is in its normally closed positioned. The clip assembly further includes a stem assembly rigidly coupling the first end of the external clip to the corresponding first end of the internal spring, and having a defined stem length that maintains the first ends of the external clip and internal spring in a spaced apart relationships. Still further, the clip assembly includes an interior retaining feature within the housing configured to prevent the second end of the interior spring from moving towards the external clip when the second end of the external clip is deflected away from the exterior bottom surface of the housing, thereby creating a spring force opposing such deflection.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of one embodiment of a system for tracking the physical activity of one or more users.

FIG. 2 is a perspective view of a wearable device for tracking the physical activity of a user, which device is referred to herein as a “tracker.”

FIGS. 3 and 4 are side and bottom views, respectively, of the tracker introduced in FIG. 2.

FIG. 5 is a perspective view of one embodiment of a charging station, having charging contacts mounted along a body section that is dimensioned so as to allow mounting of a bracelet/tracker assembly for charging.

FIG. 6 is a perspective view of one embodiment of a bracelet that is specially adapted as a carrier for the tracker of FIG. 2, for both enhancing the wearability of the tracker and for mounting of the tracker on the charging station of FIG. 5

FIG. 7 is a plan view of the bracelet introduced in FIG. 6.

FIG. 8 is a block diagram of example circuitry for the tracker introduced in FIG. 1.

FIG. 9 is a logic flow diagram of one embodiment of a method of touch-based processing implemented by a tracker having a touch interface.

FIG. 10 is a bottom perspective view of a tracker illustrating example details for a clip assembly that facilitates the wearability of the tracker.

FIGS. 11 and 12 are cutaway side and perspective views, respectively, illustrating the clip assembly in further detail and shown in context with the tracker housing.

FIG. 13 is a perspective view of the clip assembly in one embodiment.

FIGS. 14A and 14B illustrate operation of the clip assembly in one or more embodiments.

### DETAILED DESCRIPTION

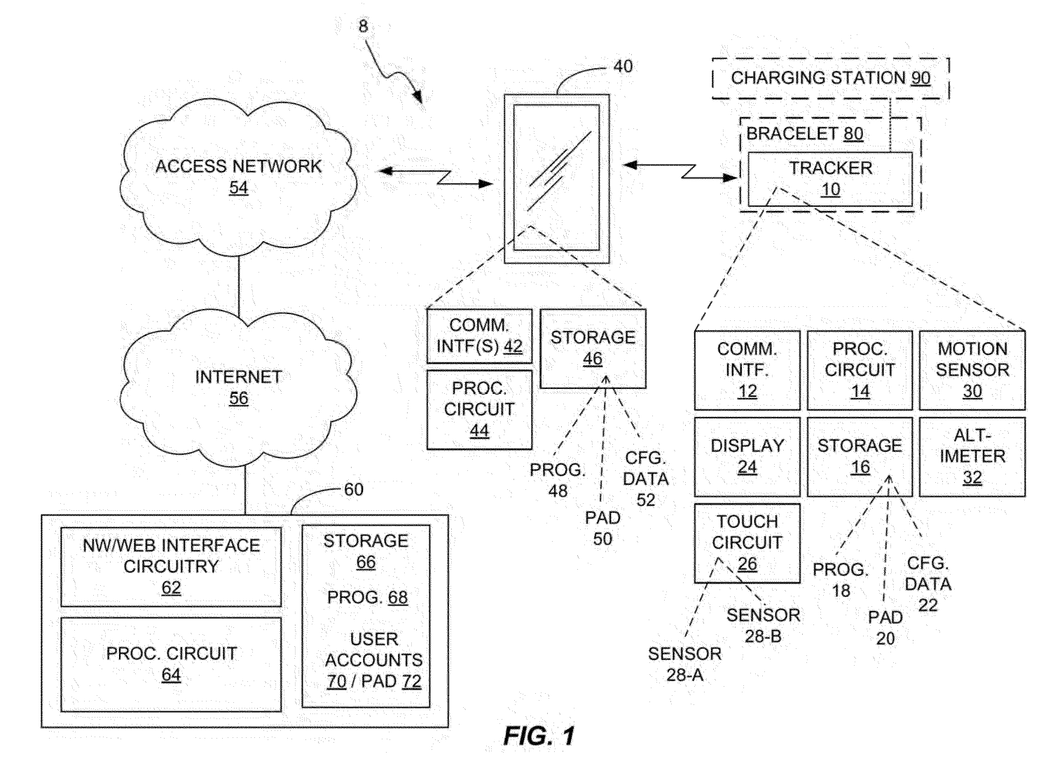

FIG. 1 illustrates one embodiment of an activity tracking system 8, including a physical-activity tracking device 10, referred to as a “tracker 10.” The below description details a number of innovative physical and/or functional features implemented in the tracker 10, including a “pinch” or “dual touch” feature that provides comprehensive interaction capabilities between the tracker 10 and its user, while simultaneously providing robust rejection of “false” inputs. The tracker 10 further provides an advantageous clipping mechanism—not shown in FIG. 1—that provides a secure yet easily manipulated engagement mechanism for coupling to a body-worn carrier. Of course, these advantages are non-limiting examples of the numerous advantages provided by the tracker 10 and overall system 8.

In more detail, the tracker 10 includes a communication interface 12 and a processing circuit 14 that includes or is otherwise associated with storage 16. In an example case, the storage 16 comprises a non-transitory computer-readable medium storing a computer program 18, physical activity data (“PAD”) 20, and one or more items of configuration data 22.

The tracker 10 additionally includes a display 24 configured to display various items of information, such as tracker status or operational information, mode information, battery charge information, one or more items of PAD 20 or data derived therefore, etc. Further, the tracker 10 includes a touch circuit 26 and at least two touch sensors 28-A and 28-B, which are used in “dual-touch” or “pinch” related processing as taught herein. Still further, the tracker 10 includes a motion sensor 30, such as a multi-axis accelerometer, and an altimeter or barometer 32.

Here and elsewhere in this disclosure, recitation of a feature or item in the singular sense shall be understood as meaning “one or more” of such features or items unless otherwise noted. For example, the communication interface 12 may comprise one or more communication interfaces, e.g., supporting different wireless communication technologies. In another example, the processing circuit 14 comprises one or more processing circuits, such as one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or other digital processing circuitry.

Similarly, the storage 16 may be wholly or partly integrated with the processing circuit 14, or communicatively coupled thereto, and may comprise more than one storage element or device, e.g., such as two or more types of memory. Examples include SRAM configured as working memory for the processing circuit 14 and EEPROM or FLASH memory configured as non-volatile, persistent storage for the computer program 18, the PAD 20 and any configuration data 22. In at least one such embodiment, the processing circuit 14 is configured to carry out the processing and supporting algorithms disclosed herein, based at least in part on its execution of computer program instructions comprising the computer program 18, which instructions may be held in working memory for execution.

FIG. 1 serves as a non-limiting example implementation of the tracker 10. Broadly, the processing circuit 14 may be implemented using fixed circuitry, programmed circuitry, or some mix thereof.

Continuing with a top-level description of FIG. 1, one sees a communication device 40, which may also be referred to as a “personal computing device” or PCD. In the example illustration, the communication device 40 includes a communication interface 42, along with a processing circuit 44. The processing circuit 44 is associated with storage 46, which stores a computer program 48—also referred to as an “app 48” or “application 48”—and further stores PAD 50 and, possibly, one or more items of configuration data 52. The PAD 50 may be a full or partial copy of the PAD 20 stored in the tracker 10, or may be a historical aggregation of PAD 20 as transferred from the tracker 10 to the communication device 40 in any number of past transfer events, or may be data derived from one or more items of PAD 20 transferred from the tracker 10.

For example, the PAD 50 may include accumulations or averages of pedometer data, as obtained from the tracker's monitoring and processing of data from the motion sensor 30. Additionally or alternatively, the PAD 50 may include accumulations or averages of barometric or elevation change data. In a non-limiting example, the app 48 is configured to obtain and process the PAD 20 at triggered and/or scheduled times, and to accumulate or otherwise process and aggregate the PAD 20, to form the PAD 50. Thus, the PAD 50 may comprise various items of PAD 20 transferred in from the tracker 10 and then aggregated or otherwise processed by the app 48 in terms of discrete physical activity events—e.g., a run or a workout—or in temporal terms, such as steps taken per day, per week, etc.

In at least some embodiments, the communication device 40 comprises a smartphone or an electronic tablet having both local and wide-area wireless communication capabilities. For example, the communication interface 42 includes a BLUETOOTH radio interface for communicatively coupling to the tracker 10. Other Radio Access Technologies (RATs) may be used to couple the tracker 10 to the communication device 40, such as Near Field Communication (NFC) links, ZIGBEE, Ultra Wideband (UWB). In other examples, inductive or optical coupling interfaces provide the local communication link between the tracker 10 and the communication device 10. Non-limiting examples of the communication device 40 include an APPLE IPHONE or IPAD device, or a SAMSUNG GALAXY phone or tablet.

In an example of wide-area connectivity, the communication device 40 includes a cellular radio modem for communications toward an access network 54. By way of non-limiting example, the access network 54 comprises a Public Land Mobile Network (PLMN), such as a Long Term Evolution (LTE) Radio Access Network (RAN) supported by an Evolved Packet Core (EPC). In any case, the access network 54 communicatively links the communication device 40 through the Internet 56 to an online computer system 60. More particularly, the access network 54 and Internet 56 communicatively link the app 48 to the online computer system 60, thereby allowing the app 48 to transfer PAD 50 from the communication device 40 to the online computer system 60, e.g., for storage in or linking to a user account corresponding to the user/owner of the communication device 40.

In this regard, it shall be understood that different trackers 10 generally are purchased and used by different users, e.g., an individual user owns and wears a given tracker 10, to track her physical activity. Thus, while FIG. 1 illustrates one tracker 10 and one communication device 40, the overall system 8 may be considered as including any number of trackers 10 and associated apps 48 running in respective ones of the users' corresponding communication devices 40.

Correspondingly, the online computer system 60 is configured to communicate with a potentially large plurality of communication devices 40 and/or trackers 10. More particularly, the online computer system 60 is configured to manage account data for a potentially large number of (tracker users), including storing and processing PAD 50 received for individual ones of those users, and, optionally, for providing individualized feedback to such users. User feedback includes, for example, statistical and/or graphical analyses of the user's PAD 50, historical PAD data, e.g., tracked over one or more intervals of time. Additionally or alternatively, the online computer system 60 uses the PAD 50 received for a given user to determine personalized health, fitness and/or lifestyle recommendations to the user. Such recommendations include, for example, recommended activities, diet or food recommendations, exercise equipment recommendations, etc.

In the illustrated example, the online computer system 60 includes network (NW) interface circuitry 62, which in at least some embodiments provides web server functionality, e.g., for use by the app 48 in some of its embodiments and/or for browser-based access via the communication devices 40 or personal computers (not shown). The online computer system 60 further includes a processing circuit 64—e.g., any one or more microprocessor-based circuits—and associated storage 66.

The storage 66 comprises one or more types of non-transitory computer readable medium and in an example configuration provides storage for a computer program 68, the execution of which configures the online computer system 60 according to the teachings herein. The storage 66 further stores user accounts 70, including user-specific PAD 72. The PAD 72 in a given user account 70 comprises, for example, comprises a full or partial copy of the PAD 50 stored in the user's corresponding communication device 40, or comprises data derived or otherwise aggregated therefrom, e.g., accumulated data, averaged data, data representing activity levels over time, etc.

Thus, it will be appreciated that the PAD 72 for each user account 70 comprises PAD 50 collected from the respective user's communication device 40 and/or data derived therefrom. In turn, the PAD 50 for a given user comprises PAD 20 collected from the user's tracker 10 and/or data derived therefrom.

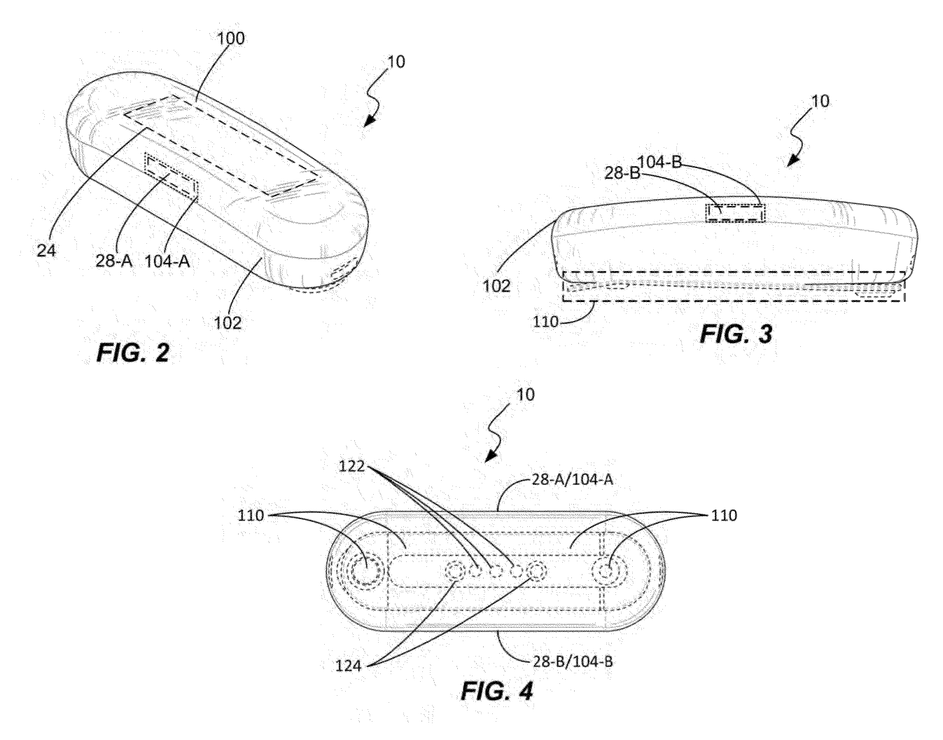

FIG. 1 further illustrates that the tracker 10, as a wearable electronic device, may be configured for detachably integrating with a bracelet 80, for convenient wearability. Further, the tracker 10 may be associated with a charging station 90. To better understand example attributes of the tracker 10, the bracelet 80 and the charging station 90, FIGS. 2-4 provide several perspective views of the tracker 10 in one or more embodiments.

FIG. 2 in particular illustrates that the display 24 of the tracker 10 may be mounted behind a transparent region 100 in an upper surface of a tracker housing 102, such that illuminated portions of the display 24 are visible through the tracker housing 102. In some embodiments, the transparent region 100 is tinted or otherwise treated so that it exhibits an opaque appearance but does not prevent impair legibility of the display 24 when the display 24 is illuminated. Further, particularly where the transparency of the tracker housing 102 is not discernable in the absence of back illumination, all or at least the top half of the tracker housing 102 may be transparent.

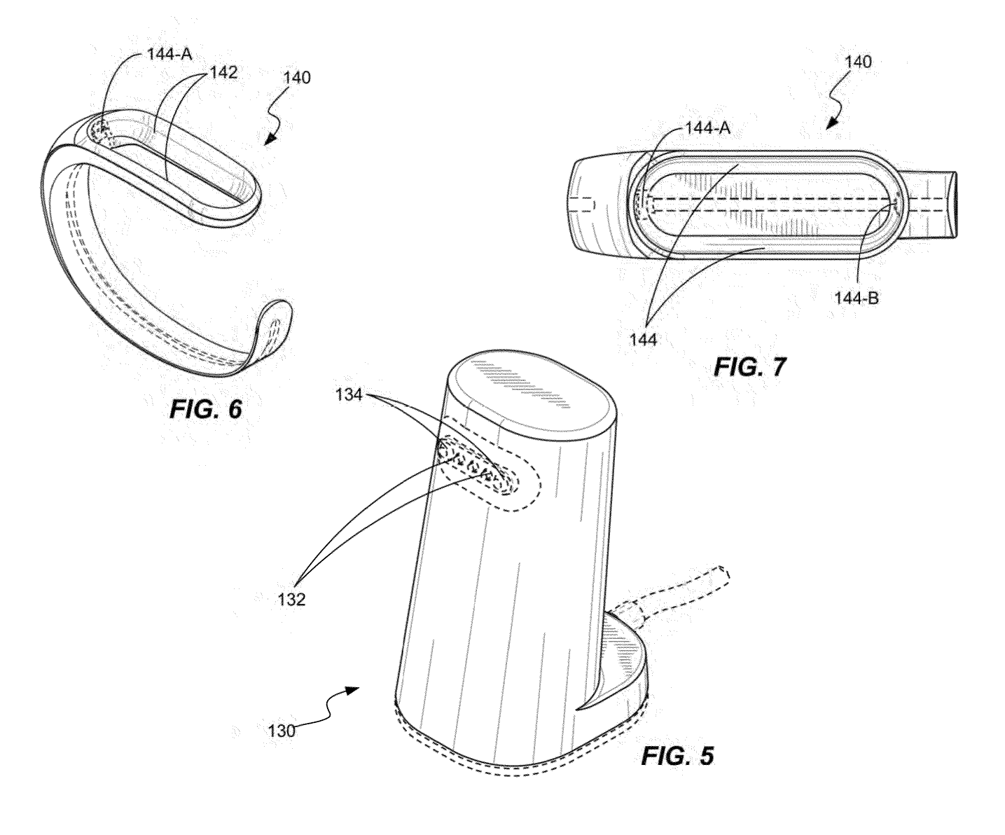

In any case, it will be appreciated that the example tracker housing 102 includes opposing exterior top and exterior bottom surfaces, opposing exterior side surfaces along the long axis of the tracker housing 102, and opposing exterior end surfaces along the short axis of the tracker housing. In this regard, FIG. 2 also illustrates an example, advantageous positioning of the touch sensor 28-A along one of the side surfaces defined by the long-axis of the tracker 10. The region of the exterior surface overlaying the touch sensor 28-A thus functions as a corresponding touch point 104-A. It will be appreciated that in this embodiment the other touch sensor 28-B is positioned within the interior of the tracker housing 102 such that its corresponding touch point 104-B is symmetrically positioned on the opposing exterior surface of the tracker housing 102, such as seen in FIGS. 3 and 4.

The use of underlying touch sensors 28-A and 28-B avoids the need for openings in the tracker housing 102—i.e., the touch sensors 28-A and 28-B are operative to sense touch through the tracker housing 102 and can thus be located inside the housing. Further, by physically separating the touch points 104-A and 104-B—e.g., by positioning them on opposing sides or ends of the tracker housing 102—the touch interface of the tracker 10 is essentially insusceptible to accidental activation by the user. Instead, to make a control input to the tracker 10 via the tracker's touch interface, the user must simultaneously touch the two physically separated touch points 104-A and 104-B on the exterior of the tracker housing 102.

A “pinching” gesture, e.g., involving the user's thumb and forefinger, represents a convenient control gesture for simultaneously contacting two touch points 104-A and 104-B having significant physical separation, whether such separation is achieved by spacing the touch points 104-A and 104-B at separate locations on the same surface, or is achieved by locating the touch points 104-A and 104-B on opposing exterior surfaces of the tracker housing 102. Thus, the dual-touch input required by the tracker 10 is also referred to as a “pinch” input, and, likewise, a detected dual-touch event may also be referred to as a “pinch event.” However, unless otherwise noted the terms “pinch” and “pinch event” are not meant to imply that the tracker 10 performs pressure or force sensing at the touch points 104-A and 104-B.

Further, it should be understood that one or more embodiments contemplated herein maintain physical separation of the touch points 104-A and 104-B without necessarily locating them on opposing sides or surfaces of the tracker housing 102. Thus, while opposing-surface positioning of the touch points 104-A and 104-B is preferred for some tracker form factors, it is also contemplated herein to simply provide sufficient physical separation between the touch points 104-A and 104-B to effectively eliminate the possibility of accidental simultaneous contact by the user with both touch points 104-A and 104-B.

It is also contemplated that there may be more than two touch points 104, where the “104” designation is used generically to refer to any one or more touch points 104 implemented via corresponding touch sensors 28. For example, there may be a first touch point 104 that is common to two or more other touch points 104. The user thus inputs different commands depending on which touch-point pairing she chooses, from among the possible pairings. A set of three such touch points 104 in that configuration yield two distinct pairings while a set of four touch points 104 with one being common to the other three yields three distinct pairings.

Regardless, in a non-limiting example of the contemplated touch sensing, the touch sensors 28-A and 28-B are implemented as a pair of electrodes, with each electrode positioned underneath the exterior surface of the tracker housing 102 at a respective one of the touch points. Correspondingly, the touch circuit 26 comprises sensing circuitry configured to sense a change in capacitance between the electrode pair, such as occurs when the user simultaneously contacts the exterior surface of the tracker housing 102 at the two touch points 104 corresponding to the electrode pair. In a non-limiting example, the touch circuit 26 comprises an MPR031EPR2 integrated circuit (IC). The MPR031EPR2 IC is a proximity capacitive touch sensor controller from FREESCALE SEMICONDUCTOR, INC., and it is configured to “drive” an attached electrode pair and correspondingly sense changes in capacitance between the electrodes.

In addition to illustrating the touch sensor 28-B and its corresponding touch point 104-B on the depicted side of the tracker housing 102, FIG. 3 depicts a mechanical clip assembly 110. The clip assembly 110 is implemented on a bottom side of the tracker housing 102 and enables the tracker 10 to be clipped to a user's clothing, for example.

FIG. 4 illustrates additional bottom-side features of the tracker 10. The illustrated features include a number of charging contacts 122, along with magnetic attachment points 124 that removably “attach” the tracker 10 to a charging station, such as the example charging station 90 shown in FIG. 5. One also sees that the various structural elements of the clip assembly 110 surround but do not cover or otherwise block access to the contacts 122 and attachment points 124.

The charging station 90 includes electrical contacts 92 that mate with and correspond to the electrical contacts 122 on the bottom side of the tracker housing 102. The charging station 90 further includes attachment contacts 94 to magnetically couple to the magnetic contacts 124 on the bottom side of the tracker housing 102.

More particularly, in an example embodiment, the tracker housing 102 is configured to mount or otherwise snap into a receptacle portion 82 of a bracelet 80, such as shown in FIGS. 6 and 7. Correspondingly, the body portion of the charging station 90 that carries the contacts 92 and 94 is dimensioned for encirclement by the bracelet 80.

In more detail, the tracker housing 102 is contoured and dimensioned to complement the size and shape of the receptacle portion 82 of the bracelet 80, such that it at least partially seats into the receptacle portion 82. The receptacle portion 82 may include within it mating features 84-A and 84-B that are configured to mate with engaging surfaces or elements of the clip assembly 110 on the bottom of the tracker housing 102. Further in this embodiment, the touch sensors 28-A and 28-B are positioned within the interior of the tracker housing 102 so that the corresponding touch points 104-A and 104-B are accessible along the side surfaces of the tracker 10 when it is fully seated into the receptacle portion of the bracelet 82.

As noted, the charging station 90 is dimensioned so that the bracelet 80 can slip over or around the body of the charging station 90 at the point where the electrical and magnetic contacts 92 and 94 of the charging station 90 are located. This configuration allows the tracker 10 to be mounted in the bracelet 80, thereby forming a tracker/bracelet assembly, which in turn mounts to the charging station 90.

It will be understood that the open bottom of the receptacle portion 82, as seen in FIG. 6, leaves the electrical and magnetic contacts 122 and 124 of the tracker 10 exposed, for coupling to the electrical and magnetic contacts 92 and 94 of the charging station 90. Thus, the bracelet 80 serves as a carrier for the tracker 10 and not only provides an aesthetic mechanism for wearing but further facilitates mounting the tracker 10 to the charging station 90, for charging.

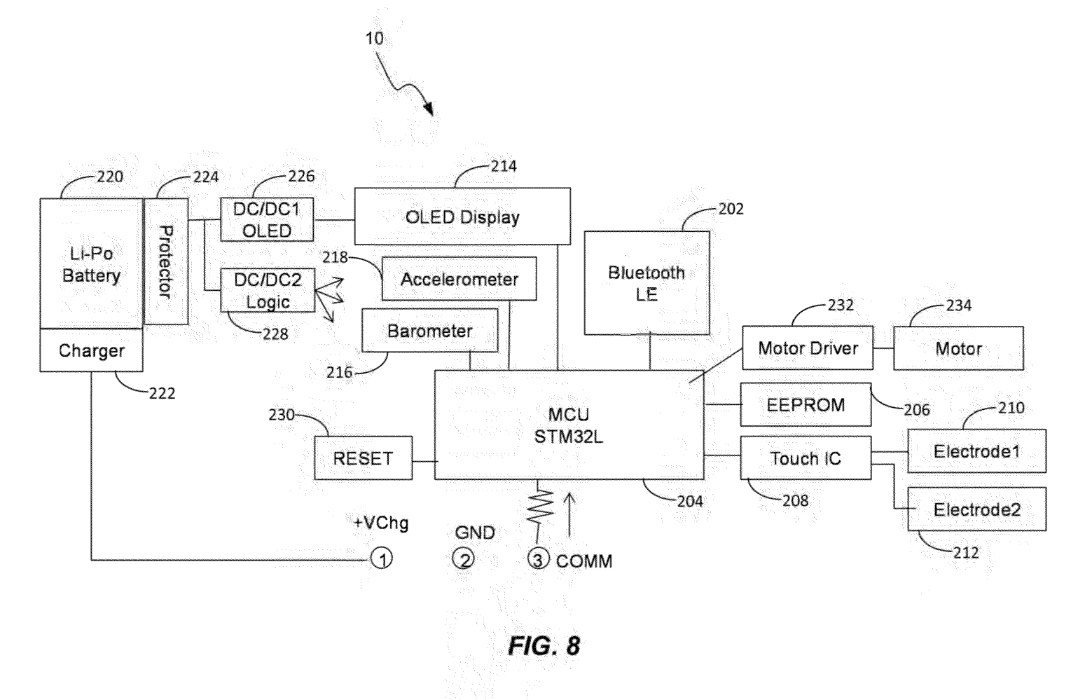

FIG. 8 illustrates a more detailed example embodiment of the tracker 10. With simultaneous reference to FIG. 1, the communication interface 12 may comprise a BLUETOOTH interface 202, such as may be implemented using a DA14580-01UNA IC from Dialog Semiconductor. The processing circuit 14 may be implemented using an ultra-low power processor, such as an STM32L processor provided by STMICROELECTRONICS and targeted for use in so called “wearable” applications.

Further, one sees that the storage 16 may be implemented using an EEPROM device 206 and that the touch circuit 26 and touch sensors 28-A and 28-B may be implemented using a touch-sensing IC coupled to a corresponding pair of electrodes 210 and 212. Additionally, the display 24 may be implemented as an OLED display unit 214, along with the motion sensor 30 being implemented as a low-power MEMS-type accelerometer, such as an ADXL362 IC from ANALOG DEVICES. Similarly, the altimeter 32 may be implemented using a low-power barometric sensor 216, such as a MEMS-based pressure sensor like the LPS331AP IC from STMICROELECTRONICS. In an advantageous alternative used in one or more other embodiments of the tracker 10, the motion sensor 30 and the altimeter 32 are implemented together in a low-power ASIC.

The tracker 10 in the illustrated example includes further miscellaneous circuits or items, including a Lithium-Polymer (Li-Po) battery 220, along with a charging circuit 222 and a protection circuit 224 that couples the Li-Po battery 220 to one or more DC/DC converters and associated control logic 226 and 228, for powering the OLED display 214 and the processing circuit 214 and its associated circuitry, such as reset circuit 230 and a motor driver 232 and motor 234 (to provide the tracker 10 with a vibrate function).

Regardless of its implementation details and the specific component types used in the tracker 10, the tracker 10 in at least some embodiments is configured to provide a relatively rich set of capabilities and to operate in various modes that provide power savings and intuitive user operation. In a “deep sleep” mode of the tracker 10, all sensors are off, and the tracker 10 operates in its lowest possible power state.

In at least one embodiment, the communication interface 12 shown in FIG. 1 implements a serial communication interface using the electrical contacts 122 provided on the bottom of the tracker housing 102. Correspondingly, the processing circuit 14 places the tracker 10 in the deep sleep mode in response to receiving a defined command via the serial interface. Additionally or alternatively, the processing circuit 14 places the tracker 10 in the deep sleep mode in response to receiving the deep sleep command via a BLUETOOTH or other wireless interface implemented via communication interface 12.

The processing circuit 14 exits the deep sleep mode responsive to detecting that the tracker 10 has been placed on the charging station 90. For example, the tracker 10 transitions from the deep sleep mode to a “normal” mode in response to being placed on the charging station 90. If while in normal mode the tracker 10 is not “connected” to a user's communication device 40, the tracker 10 advertises its presence via the communication interface 12, e.g., it sends periodic BLUETOOTH or other personal area network signaling. The current “step count” for the day may be included in the advertising data. Here, “step count” is the number of steps taken by the user, as computed by the tracker 10 based on detecting or otherwise processing output signaling from the motion sensor 30. The tracker 10 may further store stride length information for the user as part of the configuration data 22, for use in more accurately computing steps or determining corresponding distances traveled.

The configuration data 22 also may include factory-installed data, such as a password or other “key” that must be received from any communication device 40 attempting to pair with or otherwise communicate with the tracker 10. Even if not used to authenticate all communications, the password or other stored key may be required for key operations, such as updating firmware, etc. Of course, the password-based authentication may be transparent to the user. For example, the user purchases a tracker 10 that contains a factory-loaded password. When the user registers her tracker 10 with the online computer system 60, the online computer system 60 maps the serial number of the tracker 10 to the preloaded password and sends that password to the instance of the app 48 that is installed in the user's communication device 40.

In another embodiment, the password in the tracker 10 is initially set to 0 (zero). When an instance of the app 48 running on the user's communication device 40 wants to pair with the tracker 10, it uses the default password to make initial contact and then generates a new password, e.g., via a random number generator function, and the provides it to the tracker 10 as the new password. The tracker 10 replaces the default password with the new password. Performing a device reset on the tracker 10 resets to the tracker 10 to the default password, which allows the user a convenient recovery mechanism and allows the tracker 10 to be paired with a new communication device 40.

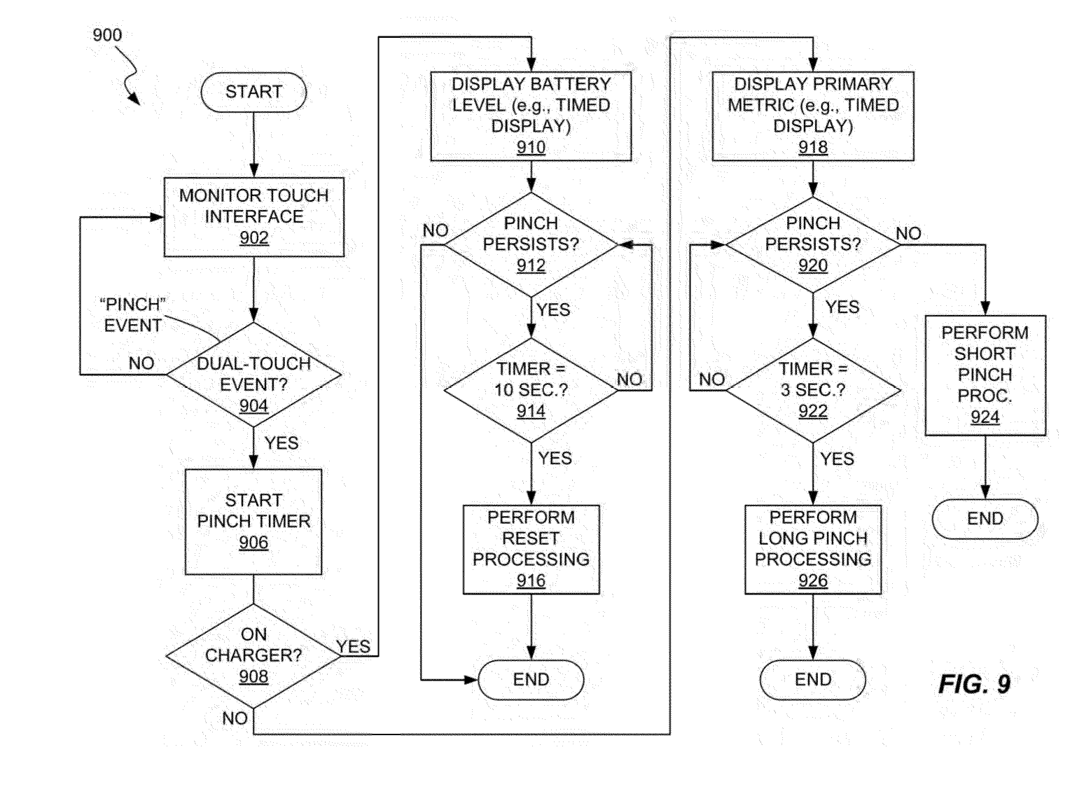

Additional aspects of the tracker's operation in one or more embodiments are detailed in FIG. 9, which depicts a method 900 that is implemented, e.g., by the processing circuit 14 based on its execution of stored computer program instructions from the computer program 18 held in the storage 16. It will be appreciated that the “start” and “end” labels in the illustrated flow do not preclude the possibility of looping or otherwise repeatedly performing the depicted processing, nor the possibility that the depicted processing is performed in conjunction with other operations, or as part of an overall processing routine.

Processing according to the example flow diagram begins with “monitoring” the touch interface of the tracker 10 (Block 902). Here, monitoring may be passive, in the sense that a low power touch IC 208, such as shown in FIG. 8, is configured to detect the change in capacitance resulting from a dual-touch event. Upon detecting a dual-touch (“pinch”) event (YES from Block 904), the tracker 10 starts a “pinch” timer (Block 906) that times the duration of the pinch event.

The tracker 10 further determines whether or not it is mounted on the charging station 90 (Block 908). The determination can be made based upon the processing circuit 14 sensing the presence of an input charging voltage, or it can be sensed, e.g., using a discrete input signal that is pulled high or low when the tracker 10 is mounted to the charging station 90, e.g., sensed as a consequence of magnetic or electrical coupling with the charging station 90.

If the tracker 10 determines that it is on the charging station 90 (YES from Block 908), it displays the current battery level (Block 910). Displaying the battery level may be a timed operation, e.g., the level is displayed for five seconds by default. However, the tracker 10 senses whether the user's pinch continues (Block 912). If the pinch persists for 10 seconds (YES from Block 914), the tracker performs reset processing (Block 916) as described below.

In at least one embodiment of reset processing, the user performs a device reset by placing the tracker 10 on the charging station 90, with the charging station plugged into an appropriate source of mains power. The user then simultaneously touches both touch sensors 28-A and 28-B and holds that contact for ten (10) seconds. In other words, the user performs a “dual touch” or “pinch” operation of ten seconds in duration. Here, a “dual touch” or “pinch” operation means that the user simultaneously touches the tracker housing 102 at the two touch points on the exterior of the tracker housing 102 corresponding to the touch sensors 28-A and 28-B. At the ten-second mark, the tracker 10 displays the phrase “RESET?” or some equivalent reset prompt for the user. If the user then releases the pinch within five (5) seconds after the tracker 10 displays the reset prompt, the tracker 10 performs the reset operation. Otherwise, the reset operation is not performed, and the tracker 10 in one or more embodiments displays a corresponding message to the user.

Broadly, when the tracker 10 is operating in its “normal” mode and is placed on the charging station 90, it cycles through a set of battery level icons or values on its display 24, e.g., 0%, 25%, 50%, 75%, 100% . . . , for ten seconds. Further, when the tracker 10 is on the charging station 90 and reaches a full charge, it uses its display 24 to display a 100% charge battery level reading or icon. And, as noted, the tracker 10 displays its current charge state for five seconds if the user pinches the tracker 10 while it is charging. The tracker 10 may also display a charging animation to inform the user that charging is underway. Also, as noted, if the pinch persists for ten seconds while the tracker 10 is charging, the tracker 10 will prompt to see if the user wishes to perform a device reset.

As for the behavior of the tracker 10 when it is pinched while not being charged (“NO” from Block 908), processing continues with displaying the current primary metric, e.g., the current day's step count (Block 918). Such processing may be based on displaying the current primary metric on a timed basis, e.g., for a default period and then shutting the display 14 off unless the pinch persists (Block 920). If the pinch is released before the pinch timer reaches three seconds (see Blocks 920 and 922), the tracker 10 performs its normal-mode short-pinch processing (Block 924). In one implementation, the primary metric display at Block 918 lasts three seconds and, if the pinch is released before the pinch timer reaches the three-second mark, the tracker 10 performs short-pinch processing by displaying the time of day for five seconds and then turning off.

Conversely, if the pinch persists for at least three seconds (YES from Block 922), the tracker 10 performs its normal-mode long-pinch processing (926). In an example case, if the pinch is held for more than three seconds, the tracker 10 uses its display 24 to continuously cycle through all of its defined primary metrics, with each metric displaying in turn for one second. If the user releases the pinch while the tracker 10 is cycling through the primary metrics in this manner, the tracker 10 will continue to display the last displayed metric for a further three seconds and then turn off.

Further, the method 900 may be extended to include a flight mode. Assuming that a pinch event has occurred and assuming that the tracker 10 is not on-charger (NO from Block 908) and is in its normal operating mode, the tracker 10 uses its pinch timer to detect whether or not the detected pinch persists for thirty (30) seconds. If so, the tracker 10 enters an “airplane” mode in which it turns off radio communications. If the tracker 10 detects another thirty-second pinch while in the airplane mode, the tracker 10 exits the airplane mode and returns to its normal mode of operation. The tracker 10 in at least one embodiment uses its display 24 to inform the user of its entry into and exit from the airplane mode.

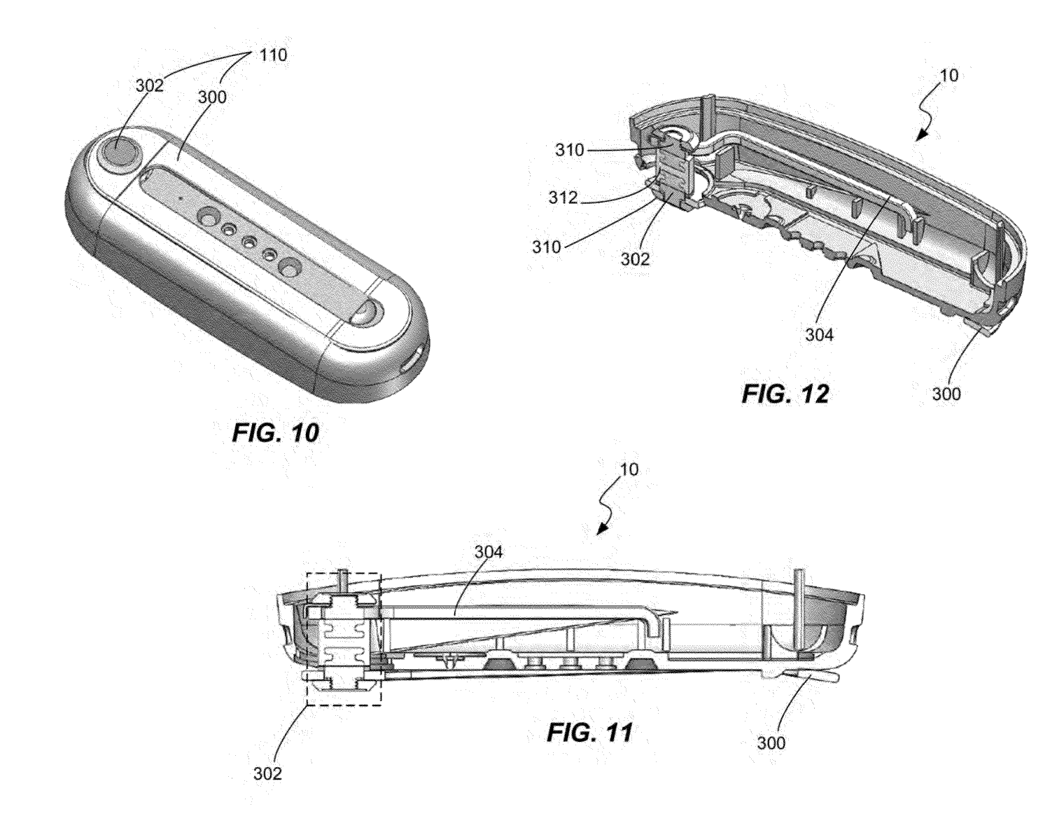

FIG. 10 illustrates that the clip assembly 110 in one or more embodiments includes an external clip 300 and a stem assembly 302 that anchors the external clip 300 to an internal spring 304, as seen in the cutaway views provided in FIGS. 11 and 12. As seen in these latter two figures, the stem assembly 302 may comprise multiple parts and it may be fabricated from steel or other metal, or from plastic (such as a fiber-reinforced plastic), or from some mix of materials. For example, in FIG. 12, one sees that the stem assembly 302 includes first and second body members 310 and an inner retaining member 312.

In one example configuration, the body members 310 are a fiber-reinforced plastic material and the inner retaining member 312 is steel or another metal. Use of plastics or other non-conductive materials for the body members 310 and/or the inner retaining member 312 provides, for example, enhanced protection against Electrostatic Discharge (ESD) for the tracker's internal circuitry.

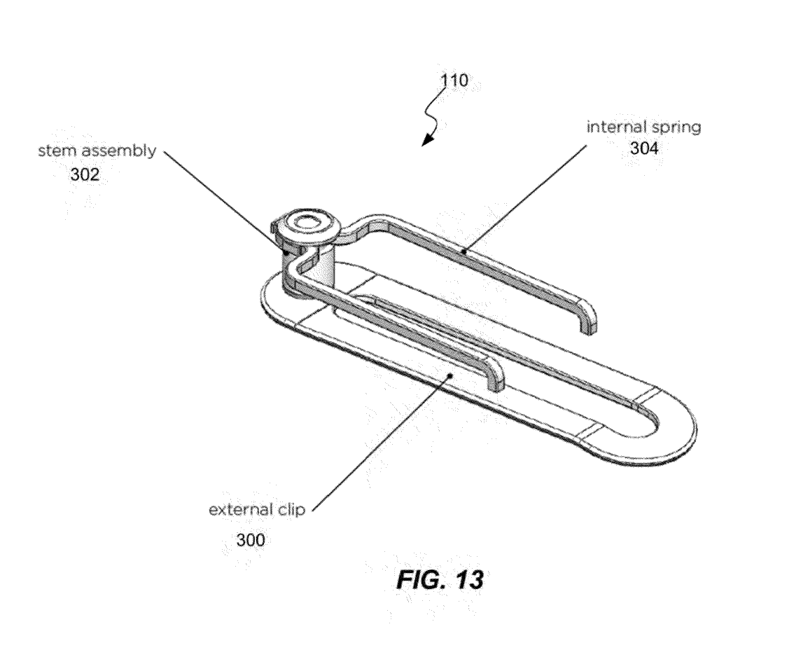

FIG. 13 illustrates an embodiment of the clip assembly 110 in more detail, where the assembly is shown divorced from the tracker 10 for improved clarity. Again, one sees the external clip 300, which is joined to the internal spring 304 via the stem assembly 302. It will be appreciated that internal features within the tracker housing 102 fixedly retain the internal spring 304 and/or stem assembly 302 for the proper operation of the clip assembly 110.

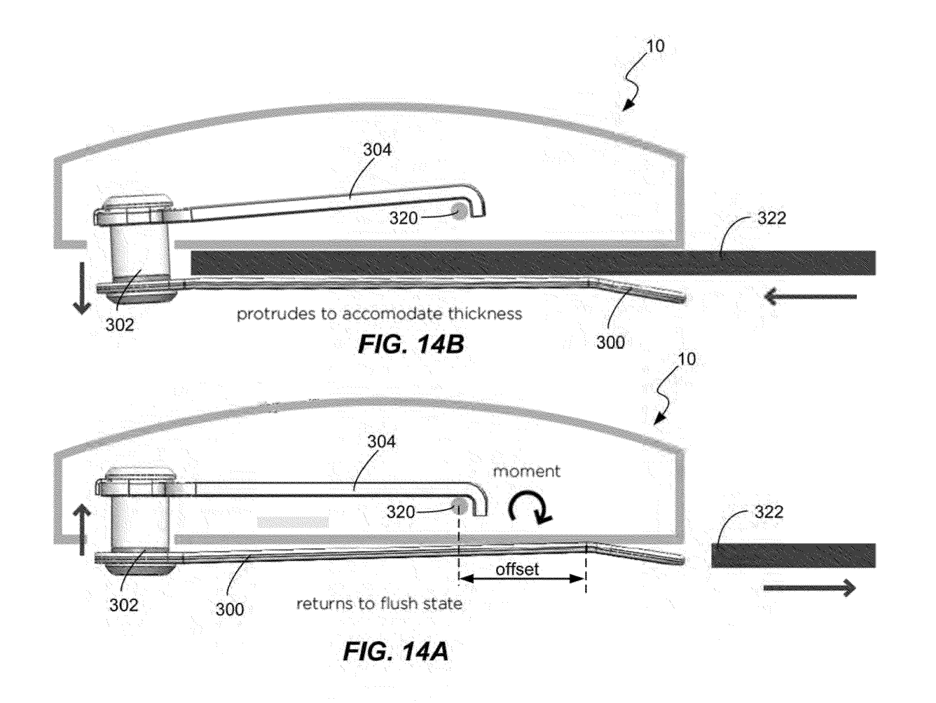

FIGS. 14A and 14B provide an example of such operation. FIG. 14A illustrates the tracker 10 in a side view and one sees that the clip assembly 110 is in its closed position. It will be appreciated that the clip assembly 110 may be resiliently biased into its closed position via the spring force created by its construction. In particular, note that a retaining post or feature 320 within the interior of the tracker housing 102 prevents the internal spring 304 from moving downward in sympathy with the external clip 300, as clothing or some other item 322 is slid in between the bottom side of the tracker housing 102 and the external clip 300. This arrangement provides for a degree of movement by the stem assembly 302, which allows the clip assembly 110 to clip to items 322 of a wider range of thicknesses, while not compromising the spring force (clipping strength) of the clip assembly 110.

Notably, modifications and other embodiments of the disclosed invention(s) will come to mind to one skilled in the art having the benefit of the teachings presented in the foregoing descriptions and the associated drawings. For example, the dual-touch event timings used herein for differentiating between control actions, and other dual-touch timing values may be varied from the values given herein.

It is recognized herein that the disclosed configuration of an electronic device for tracking physical activity particularly benefits from the dual-touch circuitry and related operation, e.g., in view of the device's intended use on or in close proximity to a user's body, in view of which portions of the device's housing are accessible when worn by the user and in view of the need for robust and reliable control in wearable device usage scenarios. However, it shall be understood that the teachings herein apply to other type of electronic devices or apparatuses. Thus, the use of dual touch points on an exterior housing and the implementation of corresponding touch detection circuitry and control algorithms supporting dual-touch control may find advantageous use in a broad range of electronic devices or apparatus having varied uses or purposes. The teachings herein are therefore not limited to wearable electronic devices used for tracking the physical activity of a user.

In general, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A wearable electronic device comprising:
a housing having an exterior surface; and
electronic circuitry mounted within the housing, said electronic circuitry including:
a touch-sensing circuit configured to provide two touch points on the exterior surface of the housing, wherein the two touch points are physically separated on the exterior surface so as to prevent accidental touch activation of the wearable electronic device by a user; and
a processing circuit operatively associated with the touch-sensing circuit and configured to control one or more functions of the wearable electronic device, responsive to detecting dual-touch events in which the user simultaneously touches both touch points.

2. The wearable electronic device of claim 1, wherein the wearable electronic device includes a user interface and wherein the processing circuit is configured to control the user interface responsive to the detected dual-touch events.

3. The wearable electronic device of claim 1, wherein the wearable electronic device has two or more defined operating modes, and wherein the processing circuit is configured to perform operating mode transitions responsive to the detected dual-touch events.

4. The wearable electronic device of claim 3, wherein the processing circuit is configured to perform operating mode transitions responsive to the detected dual-touch events in dependence on at least one of: the operating mode in which the wearable electronic device is operating when a given dual-touch event is detected, and a duration of the given dual-touch event.

5. The wearable electronic device of claim 1, further comprising a display operatively associated with the processing circuit and positioned beneath a transparent region of the exterior top surface of the housing, said display configured to display one or more items of information to the user.

6. The wearable electronic device of claim 1, further comprising at least one sensor operatively associated with the processing circuit and configured to sense physical activity of the user, including at least one of a motion sensor and a barometric pressure sensor.

7. The wearable electronic device of claim 1, wherein the processing circuit is configured to track physical activity of the user based on processing sensor output from at least one sensor included in the wearable electronic device, and to control operation of the wearable electronic device, including operation of a display included in the wearable electronic device, responsive to the detected dual-touch events.

8. The wearable electronic device of claim 1, wherein the exterior surface of the housing comprises opposing exterior top and exterior bottom surfaces, opposing exterior side surfaces along a long axis of the housing, and opposing exterior end surfaces along a short axis of the housing, and wherein the two touch points are physically separated on opposing exterior surfaces of the housing.

9. The wearable electronic device of claim 1, wherein the wearable electronic device includes a clip assembly integrated into an exterior bottom surface of the housing, said clip assembly configured to clip to an article of clothing worn by the user.

10. The wearable electronic device of claim 1, where the processing circuit is configured to implement different control actions responsive to detecting dual-touch events of different durations.

11. The wearable electronic device of claim 10, wherein, when operating in a normal operating mode, the processing circuit is configured to time the duration of a given dual-touch event and perform a first control action responsive to detecting that the duration is less than a defined first duration, and perform a second control action responsive to detecting that the duration equals a defined second duration that is longer than said first duration.

12. The wearable electronic device of claim 10, wherein, when operating in a charging mode, the processing circuit is configured to time the duration of a given dual-touch event and initiate device reset processing responsive to detecting that the duration equals a defined reset duration.

13. A physical activity tracking system comprising a wearable electronic device configured for tracking the physical activity of a user, said wearable electronic device comprising:
a housing having an exterior surface; and
electronic circuitry mounted within the housing, said electronic circuitry including:
a touch-sensing circuit configured to provide two touch points on the exterior surface of the housing, wherein the two touch points are physically separated on the exterior surface so as to prevent accidental touch activation of the wearable electronic device by the user;
a display positioned beneath a transparent region of the exterior top surface of the housing and configured to display one or more items of information to the user;
at least one sensor for sensing physical activity of the user, including at least one of a motion sensor and a barometric pressure sensor; and
a processing circuit operatively associated with the touch-sensing circuit, the display and the at least one sensor, and configured to track the physical activity of the user based on processing sensor output from the at least one sensor and to control operation of the wearable electronic device, including operation of the display, responsive to detecting dual-touch events in which the user simultaneously touches both touch points.

14. The physical activity tracking system of claim 13, wherein the physical activity tracking system includes a bracelet having a receptacle portion dimensioned to receive the wearable electronic device in a seated arrangement, and wherein the receptacle portion includes engaging features that are configured to engage with the wearable electronic device, for removably retaining the wearable electronic device in the receptacle portion of the bracelet.

15. The physical activity tracking system of claim 14, wherein the wearable electronic device includes a clip assembly integrated into an exterior bottom surface of the housing, said clip assembly configured to clip to an article of clothing worn by the user, and wherein the engaging features of the bracelet are configured to engage with the clip assembly.

16. The physical activity tracking system of claim 14, wherein the wearable electronic device includes a number of first electrical contacts on an exterior bottom surface of the housing, wherein the receptacle portion is configured to leave the first electrical contacts exposed when the wearable electronic device is seated in the receptacle portion of the bracelet, and wherein the physical activity tracking system further includes a charging station having a body portion that includes a number of second electrical contacts, said body portion dimensioned for encirclement by the bracelet, to thereby allow mating of the first and second electrical contacts when the bracelet, with the wearable electronic device is seated in the receptacle portion, is mounted on the body portion of the charging station.

17. A physical activity tracking system comprising a wearable electronic device configured for tracking the physical activity of a user, said wearable electronic device comprising:
a housing having an exterior surface defining an interior space; and
a clip assembly comprising:
an external clip comprising an elongate member extending along an exterior bottom surface of the housing and having first and second ends;
an internal spring comprising an elongate member having first and second ends extending within the interior space of the housing roughly parallel to the external clip when the external clip is in its normally closed positioned;
a stem assembly rigidly coupling the first end of the external clip to the corresponding first end of the internal spring, and having a defined stem length that maintains the first ends of the external clip and internal spring in a spaced apart relationships; and
an interior retaining feature within the housing configured to prevent the second end of the interior spring from moving towards the external clip when the second end of the external clip is deflected away from the exterior bottom surface of the housing, thereby creating a spring force opposing such deflection.
